(19) United States
(12) Patent Application Publication
(10) Pub. No.: US 2016/0321597 A1
(43) Pub. Date: Nov. 3, 2016

(54) Device, System, and Method for Team Formation

(71) Applicant: Avaya Inc., Santa Clara, CA (US)

(72) Inventors: Tony McCORMACK, Galway (IE); Neil O'CONNOR, Lackagh (IE); Paul D'ARCY, Limerick (IE)

(21) Appl. No.: 14/701,010

(22) Filed: Apr. 30, 2015

(51) Int. Cl. G06Q 10/06

(52) U.S. Cl. CPC G06Q 10/063112

(57) ABSTRACT

A device and method forms a team to be assigned to a requested service. The method as performed by a team service device includes receiving members of a service provider and the requested service, the members being selectable in forming a team. The method includes determining at least one attribute based upon the requested service. The method includes determining candidate teams where each one of the candidate teams includes at least one of the members, the at least one member collectively having the at least one attribute of the requested service. The method includes determining a respective proficiency value associated with each of the candidate teams, the proficiency value being indicative of a proficiency of each of the candidate teams in handling the requested service. The method includes selecting one of the candidate teams to be assigned in handling the requested service which has a highest proficiency value.

### BACKGROUND INFORMATION

A service provider may receive a request from a user for a service handled thereby to be addressed. For example, the service provider may utilize a request receiving feature in which the user provides details and information associated with the requested service. Subsequently, the service provider may assign an agent to the requested service. The service provider may include an automated system that determines the most appropriate and/or qualified agent or agents to be assigned to the requested service. In this manner, the service provider may efficiently handle the requested service from the user simply by satisfying any criteria the requested service may entail.

The service provider may also include a plurality of different teams that may be qualified in handling the requested service where each team satisfies the criteria of the requested service. Accordingly, the team may include one or more agents. For example, when the requested service entails a plurality of attributes that a single agent is not equipped to handle alone, then the team may include two or more agents. Although the single agent case described above may particularly benefit from an automated system selecting the most appropriate/qualified agent, a team selection for a team involving two or more agents may require further considerations to provide a most efficient solution in handling the requested service to both the service provider and the user. When a further agent is selected as a member of the team, a highly complex unstructured business process is defined which affects the efficiency in determining a solution. Furthermore, one team may be preferable over another team. For example, the concept of a team proficiency (e.g., a degree of automation applied to the team selection) is very different from what may be achieved with assigning tasks to an individual agent. That is, a selection based upon team proficiency involves more complex determinations than a selection based upon merely satisfying criteria of the requested service.

### SUMMARY OF THE INVENTION

The present invention describes a method comprising receiving, by a team service device, first and second data, the first data being indicative of a plurality of members of a service provider, the members being selectable in forming a team to handle a requested service of the service provider, the second data being indicative of the requested service; determining, by the team service device, at least one attribute as a function of the second data; determining, by the team service device, a plurality of candidate teams where each one of the candidate teams includes at least one of the members as a function of the first and second data, the at least one member collectively having the at least one attribute of the requested service; determining, by the team service device, a respective proficiency value associated with each of the candidate teams, the proficiency value being indicative of a proficiency of each of the candidate teams in handling the requested service; and selecting, by the team service device, one of the candidate teams to be assigned in handling the requested service which has a highest proficiency value.

The present invention describes a team service device comprising a transceiver configured to establish a connection to a service provider network of a service provider, the service provider network establishing a further connection to a user device that submits a request for a service; and a processor configured to receive first and second data, the first data being indicative of a plurality of members of a service provider, the members being selectable in forming a team to handle a requested service of the service provider, the second data being indicative of the requested service, the processor configured to determine at least one attribute as a function of the second data, the processor configured to determine a plurality of candidate teams where each one of the candidate teams includes at least one of the members as a function of the first and second data, the at least one member collectively having the at least one attribute of the requested service, the processor configured to determine a respective proficiency value associated with each of the candidate teams, the proficiency value being indicative of a proficiency of each of the candidate teams in handling the requested service, the processor configured to select one of the candidate teams to be assigned in handling the requested service which has a highest proficiency value.

The present invention describes a non-transitory computer readable storage medium with an executable program stored thereon, wherein the program instructs a microprocessor to perform operations comprising receiving, by a team service device, first and second data, the first data being indicative of a plurality of members of a service provider, the members being selectable in forming a team to handle a requested service of the service provider, the second data being indicative of the requested service; determining, by the team service device, at least one attribute as a function of the second data; determining, by the team service device, a plurality of candidate teams where each one of the candidate teams includes at least one of the members as a function of the first and second data, the at least one member collectively having the at least one attribute of the requested service; determining, by the team service device, a respective proficiency value associated with each of the candidate teams, the proficiency value being indicative of a proficiency of each of the candidate teams in handling the requested service; and selecting, by the team service device, one of the candidate teams to be assigned in handling the requested service which has a highest proficiency value.

### BRIEF DESCRIPTION OF THE DRAWINGS

FIG. 1 shows an exemplary team service device according to the present invention.

FIG. 2 shows an exemplary member pool according to the present invention.

FIG. 3 shows an exemplary method of forming teams according to the present invention.

FIG. 4 shows an exemplary method of selecting a team according to the present invention.

### DETAILED DESCRIPTION

The exemplary embodiments may be further understood with reference to the following description and the related appended drawings, wherein like elements are provided with the same reference numerals. The exemplary embodiments are related to a device, system, and method for automatic team formation and automatic team selection. Specifically, the exemplary embodiments provide a first mechanism in which a plurality of teams may be determined based upon a member pool where each team has at least one member (e.g., agents of a service provider) and the at least one member collectively provides a set of attributes that are associated with the team. The exemplary embodiments provide a second mechanism in which each team has an associated proficiency determined therefor and the most proficient, available team is selected to be assigned for a service being requested by a user. Accordingly, the aspects in which a team is formed and selected may be performed in an efficient manner through the exemplary embodiments. The team formation, the team selection, the mechanisms therefor, the components therefor, and related methods will be described in further detail below.

Initially, it should be noted that the exemplary embodiments described herein may be applicable to a non-real-time scenario as well as a real-time scenario. The non-real-time scenario may be when a user provides information and/or a request to the service provider and the service provider subsequently assigns a team to handle the service at a time at least a predetermined duration after the request was received. For example, an installation service may require a team to be deployed to a site. Accordingly, such a service is not performed in real-time (e.g., while a user is communicating with the service provider). However, those skilled in the art will understand that the exemplary embodiments may also be used in a real-time scenario. The real-time scenario may be when a user provides information and/or a request to the service provider and the service provider immediately assigns a team to handle the service within the predetermined duration after the request was received. More specifically, the service may be handled while the user is still in a communication session with the service provider. For example, the service provider may include a contact center in which a user may be in real-time contact with a team of agents and has the service provided during the communication session (e.g., voice call, video call, chat session, etc.). Accordingly, the exemplary embodiments are not restricted to a temporal relationship between a request for a service being received and the service being handled.

When the exemplary embodiments relate to a non-real-time communication, the service provider may utilize a system including a request receiving component from a user device. The request receiving component may be configured to receive information of the user and/or user device and the service for which the request relates. The request may be processed for delivery to further components of the system. The request receiving component may be connected in some manner to a team service device according to the exemplary embodiments as will be described in further detail below. When the exemplary embodiments relate to a real-time communication, the service provider may utilize a system including a contact center network and end devices such as at least one agent device, a supervisor device, etc. The system may also include the team service device according to the exemplary embodiments. Thus, the agents using the agent devices may form the team by the team service device that handles the service of the request during the real-time communication, as will be described in further detail below.

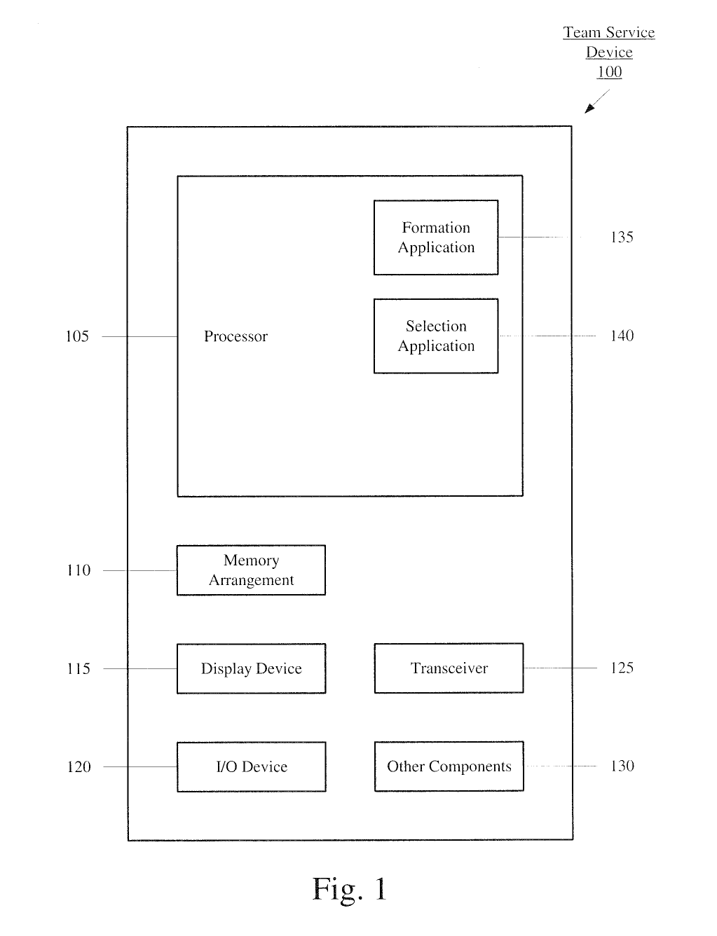

FIG. 1 shows the exemplary team service device 100 according to the present invention. The team service device 100 may be a component in a system of the service provider that performs a variety of functionalities associated with automatic team formation and automatic team selection. The team service device 100 may represent any electronic device that is configured to perform the functionalities described herein. For example, the team service device 100 may be a portable device such as a tablet, a laptop, a smart phone, etc. In another example, the team service device 100 may be a stationary device such as a desktop terminal. The team service device 100 may include a processor 105, a memory arrangement 110, a display device 115, an input/output (I/O) device 120, a transceiver 125, and other components 130 (e.g., an audio input device (for use during the video communication relating to the voice input component), an audio output device (for use during the video communication relating to the voice output component), a battery, a data acquisition device, ports to electrically connect the team service device 100 to other electronic devices, etc.).

The processor 105 may be configured to execute a plurality of applications of the team service device 100. For example, according to the exemplary embodiments, the team service device 100 may execute a formation application 135. As will be described in further detail below, the formation application 135 may automatically generate a plurality of teams based upon a member pool including agents of the service provider who may be included as a member of a team. In another example, according to the exemplary embodiments, the team service device 100 may execute a selection application 140. As will be described in further detail below, the selection application 140 may receive information of the request for a given service to determine which of the teams may provide a most efficient solution in handling the service.

It should be noted that the above noted applications, each being an application (e.g., a program) executed by the processor 105, is only exemplary. The functionality associated with the applications may also be represented as a separate incorporated component of the team service device 100 or may be a modular component coupled to the team service device 100, e.g., an integrated circuit with or without firmware. It should also be noted that the functionalities performed by the applications may be performed by other devices that provide the results to the team service device 100 and/or its applications. Furthermore, it is noted that the processor 105 may be configured to execute a variety of other applications such as a video conferencing application that may enable members of a team to communicate with one another.

The memory 110 may be a hardware component configured to store data related to operations performed by the team service device 100. Specifically, the memory 110 may store data related to the formation application 135 and the selection application 140. For example, the teams that are determined by the formation application 135 along with any associated information such as attributes may be stored on the memory 110. The member pool forming the basis upon which the teams are determined may also be stored on the memory 110.

The display device 115 may be a hardware component configured to show data to a user while the I/O device 120 may be a hardware component that enables the user to enter inputs. It should be noted that the display device 115 and the I/O device 120 may be separate components or integrated together such as a touchscreen. The transceiver 125 may be a hardware component configured to transmit and/or receive data in a wired or wireless manner. The transceiver 125 may operate on a variety of different frequencies or channels (e.g., set of consecutive frequencies) that are related to the functionalities of the different applications being performed.

As described above, a first mechanism provided by the team service device 100 is a team formation functionality via execution of the formation application 135. The team formation functionality may relate to determining at least one team from available agents who make up the member or members of the team (herein referred with “agents” or “members” even when only a single member constitutes the team). As used herein, the term “agent” and “member” may be used interchangeably when discussing a team. It should be noted that the use of agents and members as human resources is only exemplary. The exemplary embodiments may also be applicable to a team member that is a non-human resource such as a piece of equipment. Accordingly, the agents and members used herein is only exemplary when related to a human resource and may also incorporate non-human resources.

The members of the team may also collectively provide a plurality of attributes. For example, a first team member may be an implementer, a second team member may be a team worker, a third team member may be a plant, etc. Some team members may have more than one attribute such as being an implementer and a plant. In another example, the attributes may relate to knowledge related aspects such as a financial expertise, an engineering principle, etc. The combined set of attributes may form a basis upon whether a team may be qualified or capable of handling a service of the request. For example, if a service requires a first attribute and a second attribute while recommends a third attribute, a selected team must include the first and second attributes. However, a first team having the third attribute may be selected over a second team lacking the third attribute. As will be described in further detail below, the team formation functionality may determine these teams and have associated information such as the collective attributes of the team from the members included therein. It should be noted that a 1:1 ratio of attribute to team member is only exemplary. Those skilled in the art will understand that a particular attribute may require two or more members or may be fulfilled by two or more members (although a single member may also be capable of fulfilling the attribute).

Initially, the team formation functionality may be performed at a variety of times. In a first example, the team formation functionality may be performed as a preliminary process. When performed as a preliminary process, the formation application 135 may receive information regarding the agents of the service provider who may be included in the teams. For example, the team service device 100 may receive a member pool.

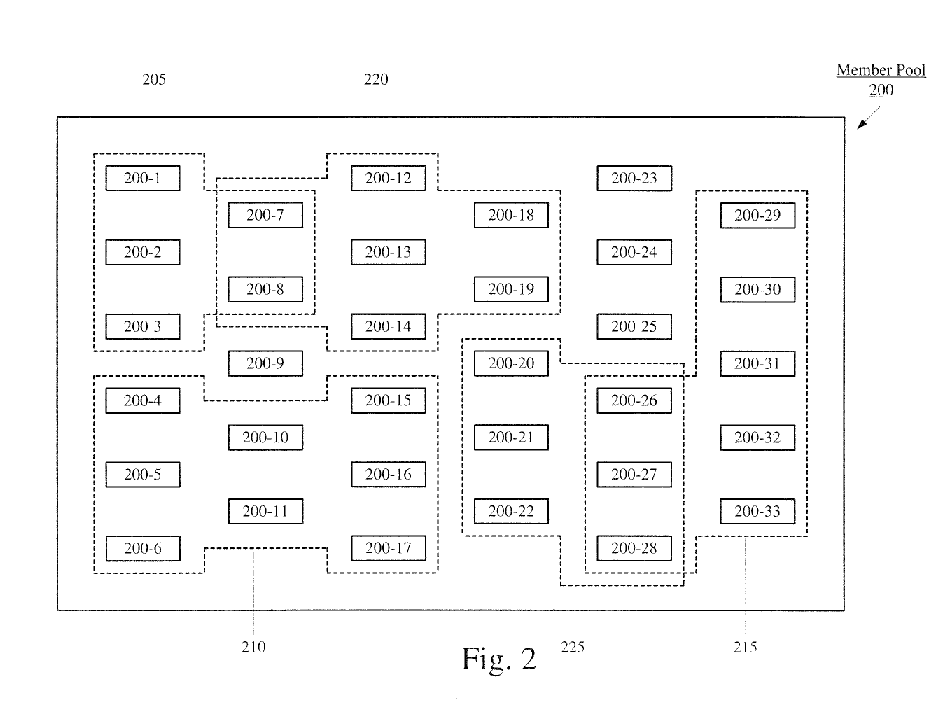

FIG. 2 shows an exemplary member pool 200 according to the present invention. As illustrated, the exemplary member pool 200 may include agents 200-1 to 200-33 who are employed or retained by the service provider. Each agent may have associated attributes. Thus, a combination of select ones of the agents 200-1 to 200-33 may form a team. For example, the formation application 135 may attempt to ascertain teams having a predetermined plurality of attributes. The predetermined attributes may relate to a particular service that is provided by the service provider. Given these predetermined attributes, the formation application 135 may determine a first candidate as team 205, a second candidate as team 210, a third candidate as team 215, a fourth candidate team as team 220, and a fifth candidate team as team 225. Each of these teams 205-225 may have, as a minimum, the attributes for which the basis was formed. However, it should be noted that the teams 205-225 may include at least one further attribute that is not part of the predetermined attributes.

The teams 205-225 may further illustrate features corresponding to how the teams are determined by the formation application 135. In a first example, the determined teams do not necessarily have a common number of members. Specifically, the team 205 includes members 200-1, 200-2, 200-3, 200-7, and 200-8 such that the team 205 has five members; the team 210 includes members 200-4, 200-5, 200-6, 200-10, 200-11, 200-15, 200-16, and 200-17 such that the team 210 has eight members; the team 215 includes members 200-26, 200-27, 200-28, 200-29, 200-30, 200-31, 200-32, and 200-33 such that the team 215 has eight members; the team 220 includes members 200-7, 200-8, 200-12, 200-13, 200-14, 200-18, and 200-19 such that the team 220 has seven members; and the team 225 includes members 200-20, 200-21, 200-22, 200-26, 200-27, and 200-28 such that the team 225 has six members. Such a scenario may arise when, for example, the members of team 210 have only one attribute contributing to the predetermined attributes while at least one of the members of team 205 have more than one of the attributes contributing to the predetermined attributes. It should again be noted that the team may include only one member if all the attributes of the requested service are satisfied by the one member.

In a second example, the determined teams may have overlapping members. As illustrated with the formation application 135 determining the team 220, the team 220 includes the above listed members. In an analytical perspective, the team members 200-1, 200-2, and 200-3 of team 205 may contribute the same attributes of the predetermined attributes as team members 200-12, 200-13, 200-14, 200-18, and 200-19 of team 220. However, it should be noted that the team 205 may have different further attributes beyond the predetermined attributes than team 220. These further attributes may contribute to, for example, recommended attributes which may affect a decision in selecting one team over another team.

Returning to the team formation functionality being performed at a variety of times, the formation application 135 may receive the member pool 200 to determine the various possible teams based upon predetermined attributes corresponding to a particular service that is to be handled. When performed as a preliminary process, the formation application 135 may receive the member pool 200 prior to receiving any request for a service. Thus, the formation application 135 may form the teams 205-225 at any time prior to the user device contacting the service provider. As discussed above, the teams 205-225 may be stored in the memory 110 along with the attribute information and/or other information associated with the respective team. The teams 205-225 may also be stored collectively to correspond to a particular service including predetermined required attributes and/or predetermined recommended attributes. In a substantially similar manner, the formation application 135 may determine one or more teams that are qualified or capable of handling each of the services to be handled by the service provider. Thus, when a request from the user device is ultimately received, the formation application 135 may determine the teams that correspond to the selected service in the request.

When using the preliminary formation approach, the formation application 135 may include a filtering functionality. Specifically, the member pool 200 may represent all agents who may be selected for a service. However, particularly when the service is performed in real-time, the agents who are available may be determined. For example, at the time the formation application 135 is executed, information may be provided that agent 200-7 is unavailable. When such information is received, the formation application 135 may initially retrieve that teams 205-225 are capable of handling the service in the request. However, with agent 200-7 being unavailable, the teams 205, 220 may be removed or filtered out of consideration as candidate teams. Thus, the formation application 135 may indicate that teams 210, 215, 225 are candidate teams.

In a second example, the team formation functionality may be a process performed when needed. When performed in this manner, the formation application 135 may receive information regarding the agents of the service provider who may be included in the teams. Again, the team service device 100 may receive the member pool 200. However, in contrast to the filtering operation being performed after the teams have been determined, the filtering operation may be performed on the member pool 200 prior to the teams being determined. Using the same example, when the team formation functionality is determined to be needed, the team service device 100 may receive the member pool 200 with the agent 200-7 omitted. Accordingly, the formation application 135 may reach the result that teams 210, 215, 225 are available. This may potentially reduce a number of calculations to be performed by the formation application 135 in determining the number of candidate teams that may handle the service in the request.

As discussed above, the teams that are determined may be associated with a service such as a selected service when teams are determined in the preliminary manner or a requested service when the teams are determined as needed. The team service device 100 may further associate the determined teams with other services if the attributes of the team also satisfy the other services. Thus, the team service device 100 may further associate each team with all available services that are capable of being handled.

As described above, a second mechanism provided by the team service device 100 is a team selection functionality via execution of the selection application 140. The team selection functionality may relate to determining which of the candidate teams is to be selected to handle the service in the request. As discussed above, the service of the request may include a predetermined number of required attributes that must be present in the team for the service to be handled or completed. Each service handled by the service provider may include this associated attribute information. This correlated information may be stored, for example, in the memory 110. Thus, the selection application 140 may receive the service to be handled and retrieve the predetermined attributes corresponding thereto. Subsequently, the candidate teams for the service may also be retrieved from the formation application 135 or the memory 110 is stored previously thereon.

After determining the candidate teams from which a selection may be made for the pending service, the selection application 140 may perform further functionalities to determine which one of the candidate teams is to be selected. According to the exemplary embodiments, a proficiency parameter may be used as a basis in which the selection application 140 is configured to select among the candidate teams. Due to the nature of a proficiency parameter such as its subjectivity, the service provider may utilize any standard to determine the proficiency associated with each team in handling of the service. That is, an administrator of the system of the service provider may include predetermined aspects in which to determine the proficiency parameter.

In a first example, the proficiency parameter may incorporate a past history in handling of a substantially similar service by the selected team. A substantially similar service may be an actual equivalent of the service or may be any service that has at least a predetermined amount of overlapping predetermined attributes (e.g., 90% overlap). If the team successfully handled the service in an efficient manner such as using low resources and low time, this team may be given a proficiency value greater than a team that successfully handled the service but in a less efficient manner such as using high resources and high time. Teams that previously did not handle the service may be given a default proficiency value (e.g., a value between the above noted examples of teams that previously handled the service). Accordingly, the selection application 140 may rank the candidate teams according to this proficiency parameter. The ranked candidate teams may be stored as a list in the memory 110.

In a second example, the service may have predetermined recommended attributes that if the team were to have such an attribute may enable the service to be handled in a more efficient manner. Therefore, although the candidate teams may have been determined based upon the predetermined required attributes, the proficiency parameter may be determined based upon the predetermined recommended attributes. As discussed above, since the candidate teams likely have different members therein, the further attributes may vary from team to team. Thus, the selection application 140 may perform a process in determining which candidate team has the most predetermined recommended attributes that become incorporated in the proficiency value to generate the list.

In a third example, the selection application 140 may determine a proficiency value based upon resource consumption. As discussed above, each candidate team may have a different number of members therein. Thus, a candidate team having less members may utilize less resources of the service provider. Accordingly, the proficiency parameter may incorporate a member number of the candidate team in determining the proficiency value. Other considerations in resource consumption may relate to future services to be handled which may make a particular member unavailable and thereby the candidate team as well. Such a consideration may be incorporated into the proficiency parameter as the candidate team being selected may cause the future service to become delayed. Thus, the selection application 140 may perform a process in determining resource consumption that becomes incorporated in the proficiency value to generate the list.

Once the list has been created, the selection application 140 may determine an availability of the most proficient team among the candidate teams. Although the formation application 135 may have already omitted teams where at least one member may be unavailable such that the team is also unavailable, there may be subsequent reasons for why a candidate team that was determined by the formation application 135 is unavailable when the selection application 140 is performing its functionality. For example, a different request for a different service may have been received at a similar timeframe as the current request. Although the candidate teams included team 205, the different service may also utilize a team that includes member 200-7. Therefore, with regard to the present selection, the team 205 may be unavailable in view of member 200-7 being unavailable. If the selection application 140 has determined that the most proficient team is available, this team may be selected to handle the requested service. However, if the selection application 140 has determined that the most proficient team is unavailable, the selection application 140 may remove this unavailable team from the candidate teams and determine the most proficient team among the remaining candidate teams. This process may continue until an available candidate team is found and selected for the requested service. Although the most proficient team may not be selected for the service, a still adequately performing team may be selected such that an overall efficiency in handling of services by the service provider may be maintained.

It should be noted that if all teams are discovered to be unavailable, the selection application 140 may be configured with a further functionality. Specifically, the further functionality may be a wait list operation. The wait list operation may place the requests for a service having no available candidate teams into a queue such that when a candidate team becomes available, the team may be assigned for the requests in the queue in the order they were received or based upon a predetermined priority parameter. It should be noted that the timing and priority parameter are only exemplary. Those skilled in the art will appreciate that any ranking method may be used for this operation.

It should also be noted that the use of a proficiency parameter is only exemplary. Those skilled in the art will understand that any parameter may be used to rank the candidate teams in a list for the selection application 140 to begin a selection process of availability. In fact, the use of a ranking priority is also only exemplary. For example, the selection application 140 may simply select a candidate team at random for the requested service in view of the attributes being collectively present within the candidate team.

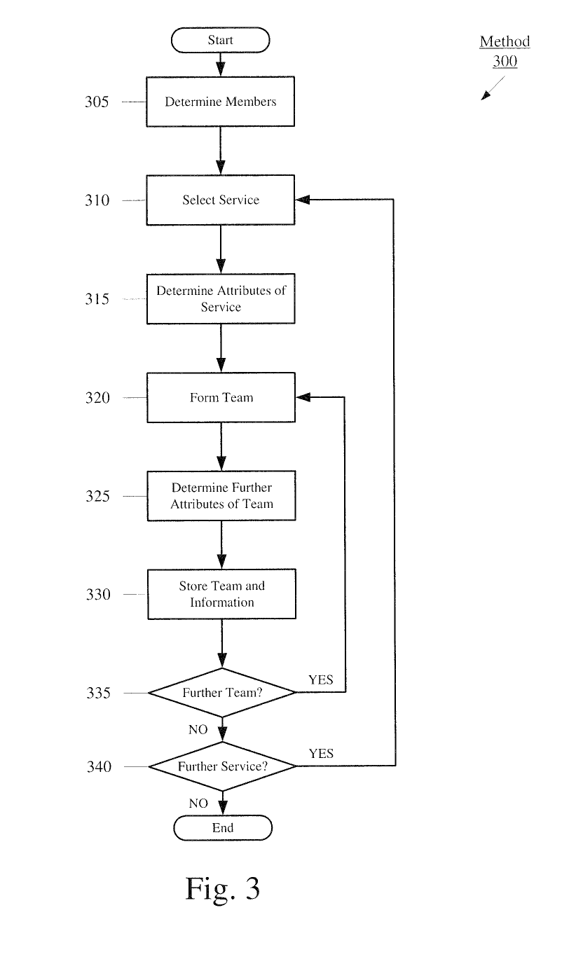

FIG. 3 shows an exemplary method 300 of forming teams according to the present invention. Specifically, the method 300 may relate to an execution of the formation application 135 so candidate teams are determined for a given service. The method 300 will be described with regard to the team service device 100 of FIG. 1 and the member pool 200 of FIG. 2. As discussed above, the method 300 may be performed at different times relative to receiving the request for the service. However, the method 300 will be described with regard to a non-real-time handling of the service.

Initially, the team service device 100 may receive the member pool 200 from the system of the service provider. For example, when regarding non-real-time services, the member pool 200 may include the agents who are employed or retained by the service provider. The member pool may be provided to the team service device 100 and stored in the memory 110.

In step 305, the team service device 100 may execute the formation application 135 to determine the members or agents in the member pool 200 such as members 200-1 to 200-33. For example, the members of the member pool 200 may have associated information such as attributes which contribute to handling of services. In another example, the members of the member pool 200 may have availability information. The availability information may indicate whether the member is currently available, whether the member is unavailable at a known future time, etc. As discussed above, the member 200-7 may be unavailable for a variety of reasons. Using this availability information, the formation application 135 may filter the member pool 200.

In step 310, the formation application 135 may select a service for which the team formation functionality is to be performed. As discussed above, if the service is performed in non-real-time, the formation application 135 may perform this functionality as a preliminary process. In step 315, the formation application 135 may determine attributes of the selected service. Specifically, the formation application 135 may select a service that is handled by the service provider and determine the attributes of this service. The team service device 100 may have received information regarding the different services that are handled by the service provider where each service has associated attribute information.

In step 320, the formation application 135 may form a team related to this selected service. Thus, the formation application 135 may determine the attributes associated with this selected service such as those that are required and/or recommended to determine a team capable of handling the service such as team 205. In step 325, the formation application 135 may determine the further attributes that are included in the team 205 beyond the required attributes of the selected service. In step 330, the team 205 and all associated information including the further attribute information is stored in the memory 110 as corresponding to the selected service.

In step 335, the formation application 135 determines whether any further teams may be created from the member pool 200 for the selected service. If there is at least one further team such as team 210, 215, or 220, the formation application 135 returns the method 300 to step 320. However, if all the teams have been determined, the formation application 135 continues the method 300 to step 340. In step 340, the formation application 135 determines whether any further services may be used as the basis to determine the teams. If there is at least one further service, the formation application 135 returns the method 300 to step 310. However, if all the services have been used as a respective basis to form the teams, the method 300 ends. Accordingly, the team service device 100 may have stored each service where each service has at least one candidate team associated therewith where each team has associated information.

It should again be noted that the above method 300 is described with regard to a non-real-time handling of services. However, as discussed above, the exemplary embodiments may relate to a handling of services in real-time. When regarding real-time services, the method 300 may be performed in different ways. For example, the formation application 135 may not select a service but instead receive the request of the service to determine the candidate teams that are available. The filtering of the member pool 200 may also be performed at a subsequent time such as after receiving the request for the service based upon, for example, the agents who are currently connected to a contact center network via login information of agent devices.

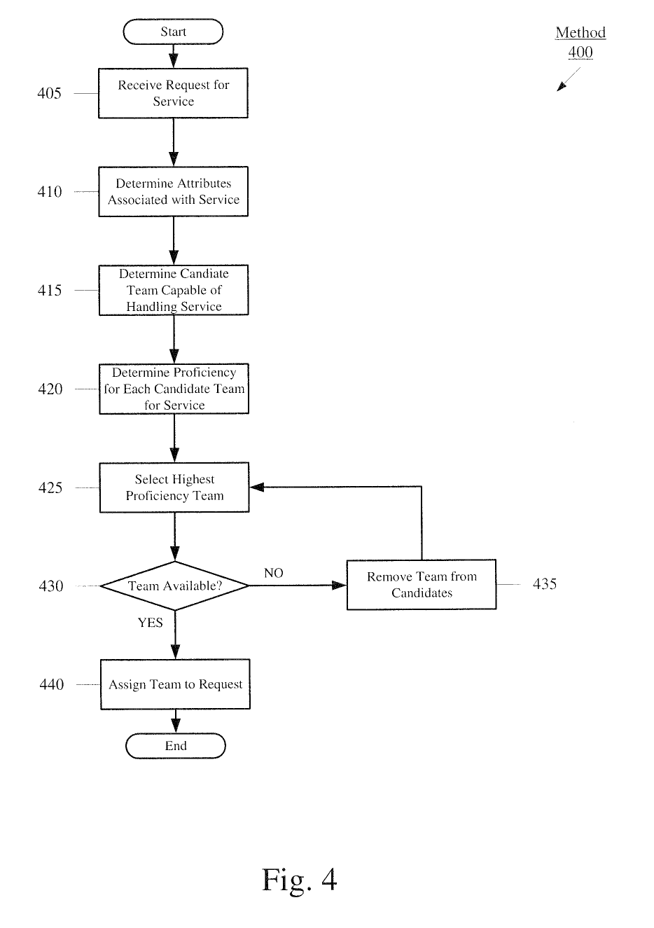

FIG. 4 shows an exemplary method 400 of selecting a team according to the present invention. Specifically, the method 400 may relate to an execution of the selection application 140 so one of the candidate teams is selected to handle a requested service. Thus, the method 300 may have already been performed to determine the candidate teams for a selected service. The method 400 will be described with regard to the team service device 100 of FIG. 1 and the member pool 200 of FIG. 2.

In step 405, the service provider system may receive a request for a service from a user device. In step 410, the service provider system and/or the team service device 100 may determine the attributes associated with the requested service. With this information, in step 415, the selection application 140 may determine the candidate teams capable of handling the service based upon the determination from the formation application 135 performing its functionality.

In step 420, the selection application 140 determines a proficiency for each candidate team determined for the requested service. As discussed above, a proficiency value for each team may be determined based upon predetermined parameters selected in determining this value. For example, the further attributes of the teams may be used when comparing to predetermined recommended attributes associated with the requested service. In another example, resource allocation or use may be considered in determining the proficiency value of the teams. In yet another example, at least one prior performance of the service or substantially similar service may be used as a consideration in determining the proficiency value. Once the proficiencies for each candidate team is determined, the selection application 140 may sort, rank, or list the candidate teams based upon this standard. However, it should again be noted that the use of the proficiency value is only exemplary and the selection application 140 may utilize any standard or process for the subsequent steps.

In step 425, the selection application 140 selects a candidate team having the highest proficiency value based upon the list generated previously. In step 430, the selection application 140 determines whether this selected candidate team is available to handle the requested service. If the team is not available, the selection application 140 continues to step 435. In step 435, the selection application removes this team from the candidate teams. Subsequently, the selection application 140 returns the method 400 to step 425. This process may continue until the selection application 140 determines that a selected candidate team is available. Thus, in step 440, the selection application 140 assigns the team to handle the requested service. In this manner, the highest proficiency team that is available is always selected in assignment for the service.

The exemplary embodiments provide a device, system, and method of forming teams in handling a service of a service provider. The team may be formed based upon a variety of factors such as attributes associated with the service. The team which includes a plurality of members may collectively include the attributes among other further attributes. When multiple candidate teams are determined to be capable of handling the service, the exemplary embodiments may further be configured to select one of the candidate teams that has a highest proficiency.

Those skilled in the art will understand that the above-described exemplary embodiments may be implemented in any suitable software or hardware configuration or combination thereof. An exemplary hardware platform for implementing the exemplary embodiments may include, for example, an Intel x86 based platform with compatible operating system, a Mac platform and MAC OS, a mobile device having an operating system such as iOS, Android, etc. In a further example, the exemplary embodiments of the above described method may be embodied as a program containing lines of code stored on a non-transitory computer readable storage medium that, when compiled, may be executed on a processor or microprocessor.

It will be apparent to those skilled in the art that various modifications may be made in the present invention, without departing from the spirit or the scope of the invention. Thus, it is intended that the present invention cover modifications and variations of this invention provided they come within the scope of the appended claims and their equivalent.

What is claimed is:

1. A method, comprising:
receiving, by a team service device, first and second data, the first data being indicative of a plurality of members of a service provider, the members being selectable in forming a team to handle a requested service of the service provider, the second data being indicative of the requested service;
determining, by the team service device, at least one attribute as a function of the second data;
determining, by the team service device, a plurality of candidate teams where each one of the candidate teams includes at least one of the members as a function of the first and second data, the at least one member collectively having the at least one attribute of the requested service;
determining, by the team service device, a respective proficiency value associated with each of the candidate teams, the proficiency value being indicative of a proficiency of each of the candidate teams in handling the requested service; and
selecting, by the team service device, one of the candidate teams to be assigned in handling the requested service which has a highest proficiency value.

2. The method of claim 1, further comprising:
prior to selecting, determining, by the team service device, an availability of the candidate teams; and
removing, by the team service device, any one of the candidate teams determined to be unavailable.

3. The method of claim 1, further comprising:
prior to determining the candidate teams, determining, by the team service device, an availability of each of the members; and
removing, by the team service device, any one of the members determined to be unavailable.

4. The method of claim 1, further comprising:
determining, by the team service device, at least one further attribute respective of each of the candidate teams, the at least one further attribute forming at least a portion of the basis upon which the proficiency value is determined.

5. The method of claim 1, further comprising:
determining, by the team service device, prior performance history data of each of the candidate teams in handling the requested service, the prior performance history data forming at least a portion of the basis upon which the proficiency value is determined.

6. The method of claim 1, further comprising:
determining, by the team service device, resource consumption data of each of the candidate teams in handling the requested service, the resource consumption data forming at least a portion of the basis upon which the proficiency value is determined.

7. The method of claim 1, wherein a first one of the candidate teams includes a first number of members and a second one of the candidate teams includes a second number of members different from the first number.

8. The method of claim 2, further comprising:
determining, by the team service device, that all candidate teams are unavailable; and
placing, by the team service device, the requested service into a wait list, the wait list indicating an order in which the requested service is handled upon one of the candidate teams becoming available.

9. The method of claim 1, further comprising:
determining, by the team service device, at least one further attribute as a function of third data indicative of a further requested service; and
determining, by the team service device, at least one of the candidate teams, the at least two of the members thereof collectively having the at least one further attribute of the further requested service.

10. The method of claim 1, wherein the requested service is handled one of in real-time and in non-real-time.

11. A team service device, comprising:
a transceiver configured to establish a connection to a service provider network of a service provider, the service provider network establishing a further connection to a user device that submits a request for a service; and
a processor configured to receive first and second data, the first data being indicative of a plurality of members of a service provider, the members being selectable in forming a team to handle a requested service of the service provider, the second data being indicative of the requested service, the processor configured to determine at least one attribute as a function of the second data, the processor configured to determine a plurality of candidate teams where each one of the candidate teams includes at least one of the members as a function of the first and second data, the at least one member collectively having the at least one attribute of the requested service, the processor configured to determine a respective proficiency value associated with each of the candidate teams, the proficiency value being indicative of a proficiency of each of the candidate teams in handling the requested service, the processor configured to select one of the candidate teams to be assigned in handling the requested service which has a highest proficiency value.

12. The team service device of claim 11, wherein, prior to selecting, the processor is further configured to determine an availability of the candidate teams and remove any one of the candidate teams determined to be unavailable.

13. The team service device of claim 11, wherein, prior to forming, the processor is further configured to determine an availability of each of the members and remove any one of the members determined to be unavailable.

14. The team service device of claim 11, wherein the processor is further configured to determine at least one further attribute respective of each of the candidate teams, the at least one further attribute forming at least a portion of the basis upon which the proficiency value is determined.

15. The team service device of claim 11, wherein the processor is further configured to determine prior performance history data of each of the candidate teams in handling the requested service, the prior performance history data forming at least a portion of the basis upon which the proficiency value is determined.

16. The team service device of claim 11, wherein the processor is further configured to determine resource consumption data of each of the candidate teams in handling the requested service, the resource consumption data forming at least a portion of the basis upon which the proficiency value is determined.

17. The team service device of claim 11, wherein a first one of the candidate teams includes a first number of members and a second one of the candidate teams includes a second number of members different from the first number.

18. The team service device of claim 12, wherein the processor is further configured to determine that all candidate teams are unavailable and place the requested service into a wait list, the wait list indicating an order in which the requested service is handled upon one of the candidate teams becoming available.

19. The team service device of claim 11, wherein the processor is further configured to determine at least one further attribute as a function of third data indicative of a further requested service and determine at least one of the candidate teams, the at least two of the members thereof collectively having the at least one further attribute of the further requested service.

20. A non-transitory computer readable storage medium with an executable program stored thereon, wherein the program instructs a microprocessor to perform operations comprising:
receiving, by a team service device, first and second data, the first data being indicative of a plurality of members of a service provider, the members being selectable in forming a team to handle a requested service of the service provider, the second data being indicative of the requested service;
determining, by the team service device, at least one attribute as a function of the second data;
determining, by the team service device, a plurality of candidate teams where each one of the candidate teams includes at least one of the members as a function of the first and second data, the at least one member collectively having the at least one attribute of the requested service;
determining, by the team service device, a respective proficiency value associated with each of the candidate teams, the proficiency value being indicative of a proficiency of each of the candidate teams in handling the requested service; and
selecting, by the team service device, one of the candidate teams to be assigned in handling the requested service which has a highest proficiency value.
